(19) United States
(12) Patent Application Publication
(10) Pub. No.: US 2011/0221929 A1
(43) Pub. Date: Sep. 15, 2011

(54) IMAGING EQUIPMENT AND EXPOSURE CONTROL METHOD OF THE SAME

(75) Inventors: Hiroyuki MIYAHARA, Hitachinaka (JP); Akira ANDO, Chigasaki (JP)

(73) Assignee: Hitachi, Ltd.

(21) Appl. No.: 13/030,299

(22) Filed: Feb. 18, 2011

(30) Foreign Application Priority Data
Mar. 12, 2010 (JP) 2010-055253

(51) Int. Cl. H04N 9/73

(52) U.S. Cl. 348/226.1; 348/E09.051

(57) ABSTRACT

A flicker is caused by a light lit on a commercial AC power. An iris priority camera cannot fix a shutter thereof to a shutter speed at which no flicker occurs. Each of images picked up by a surveillance camera provides precious information. Therefore, even when the shutter is set to a high shutter speed, images devoid of an afterimage or a blue have to be picked up even from a subject which makes movements. When a decision is made that a flicker is present, the timings of applying a discharging pulse and a charge readout pulse respectively are varied depending on a field in order to implement shutter speed control in a CCD sensor, so that a camera can be exposed to a portion of light falling into the same phase thereof within a luminescence period of a lighting during each field. The CCD sensor can be exposed to the light without occurrence of a flicker even when a light source emits light while being repeatedly lit and extinguished.

### CLAIM OF PRIORITY

The present application claims priority from Japanese Patent Application No. 2010-055253 filed on Mar. 12, 2010, the content of which is hereby incorporated by reference into this application.

### BACKGROUND OF THE INVENTION

1. Field of the Invention

The present invention relates to imaging equipment that removes a flicker caused by a periodic luminescent light source, and a control method thereof.

2. Description of the Related Art

As an image sensor that converts an optical image into an electrical signal, for example, a solid-state imager such as a charge-coupled device (CCD) sensor is widely adapted to camera products for private use or for surveillance. In the camera products, exposure control is implemented by controlling an iris, controlling a shutter speed of the image sensor that uses an electronic shutter, performing automatic gain control (AGC), or controlling a neutral density (ND) filter. Automatic exposure (AE) control is intended to attain a predetermined exposure target value, whereby a certain exposure quantity is provided. When the CCD sensor is adopted as the image sensor, a charge is controlled.

The AE is achieved using program AE in which whichever of the foregoing methods of controlling an iris, controlling a shutter speed (shutter open time), or performing AGC is selected based on an illuminance level of a camera. The program AE falls into various kinds of AE such as shutter priority program AE and iris priority program AE. The various kinds of program AE are used for different imaging scenes or different environments.

In the program AE, when a scene is imaged using a light source whose amount of light periodically varies depending on a commercial power frequency of a non-inverter system fluorescent light or a light emitting diode (LED) lighting, if a duration of a commercial power and a period of one field during which one frame of a camera image is outputted differ from each other, a charge differs from one field to another. This leads to occurrence of a flicker that is a flicker appearing in an image. Therefore, flicker removal processing is a mandatory technique.

FIG. 1A to FIG. 1G show a flicker deriving from a fluorescent light that causes a charge to periodically fluctuate at intervals of a certain period or at a frequency of 100 Hz. As indicated as a light-source luminescent period in FIG. 1A, when a non-inverter system fluorescent light (hereinafter referred to as a fluorescent light) is used at a commercial alternating current (AC) power frequency of 50 Hz, a luminous quantity of the fluorescent light changes at the frequency of 100 Hz that is a double of the power frequency of 50 Hz.

FIG. 1B shows a charge accumulated in the CCD sensor in a video camera, which outputs an image at sixty frames per sec in conformity with the NTSC standard that is a television broadcast system, during each field on the assumption that the fluorescent light emits light at intervals of a luminescence period thereof or at the frequency of 100 Hz and a shutter speed is set to 1/180 sec. FIG. 10 shows the timing of beginning accumulation of charge in response to a discharging pulse applied to a CCD. FIG. 1D shows the timing of terminating the accumulation of charge in response to a charge transfer pulse applied to the CCD. When the luminous quantity changes, the charge in the CCD sensor differs, as shown in FIG. 1B, from one field to another despite the same subject. The difference causes a flicker to appear and deteriorates a recorded image.

As already known, assuming that the frequency of a commercial AC power is T [Hz], when the shutter speed is fixed to n/2 T sec (where n denotes a natural number of 1, 2, 3, etc.), the flicker can be removed. Specifically, when a fluorescent light that emits light at intervals of a luminescence period thereof or at the frequency of 100 Hz is used, if the shutter speed is fixed to 1/100 sec, which is equal to the light-source luminescent period, at the accumulation beginning timing shown in FIG. 1F and at the accumulation termination timing shown in FIG. 1G, the same charge can be ensured for each frame and no flicker occurs. In the past, a method of fixing the shutter speed to n/2 T sec on the assumption that the frequency of the commercial AC power is T [Hz] has been an effective approach capable of preventing occurrence of a flicker (in contrast, if the shutter speed is not n/100 sec, a charge differs from one field to another, and a flicker occurs).

Even when an LED lighting such as an LED panel a demand for which has increased in recent years and which emits light with a commercial AC power is adopted, a camera image is quite susceptible to a flicker caused by the LED lighting. The luminescence characteristic of the LED lighting is different from that of the fluorescent light. Namely, as soon as an applied voltage exceeds a threshold, the LED lighting emits light. In other words, the LED lighting emits light while being repeatedly lit and extinguished. Since the luminous intensity of the LED lighting is larger than that of the fluorescent light, a terrible flicker occurs.

The LED lighting has come to be widely used for various purposes in recent years. A method of lighting the LED lighting falls into two methods of direct current (DC) operation and pulse operation respectively. The LED lighting often emits light according to the pulse operation by utilizing a readily-available commercial AC power. In a signal that is equipment using the LED lighting, LED elements are lit by a simple drive circuit in consideration of reliability, that is, the LED elements are lit by applying a voltage obtained by performing full-wave rectification on the commercial AC power. The luminescence period is 2 T [Hz] or identical to that of the non-inverter system fluorescent light. When a shutter speed is fixed to n/2 T sec, a flicker can, similarly to a flicker caused by a fluorescent light, be removed.

FIG. 2A to FIG. 2G show a flicker deriving from an LED lighting which causes a charge to periodically vary at intervals of a certain period or at a frequency of 100 Hz. FIG. 2A shows a luminescence period of the LED lighting that emits light at intervals of a duration of a commercial AC power or at a frequency of 50 Hz. In a camera whose shutter speed is fixed to 1/180 sec and which supports an NTSC-conformable field frequency of 60 Hz, charge is, as shown in FIG. 2B, accumulated with an accumulation beginning timing and accumulation termination timing determined as indicated in FIG. 2C and FIG. 2D respectively. In addition, the shutter speed is fixed to 1/100 sec, and charge is accumulated as indicated in FIG. 2E with the accumulation beginning timing and accumulation termination timing determined as indicated in FIG. 2F and FIG. 2G respectively.

The LED lighting is repeatedly lit and extinguished to emit light of a nearly rectangular wave. When the camera conforms to the NTSC standard stipulating the field frequency of 60 Hz, if the shutter speed is set to 1/100 sec identical to the light-source luminescent period, a flicker can be removed. When the shutter speed is set to 1/180 sec, the LED lighting emits light while being repeatedly lit and extinguished at intervals of the period or at a frequency of 100 Hz. Therefore, in whichever of phases of the light in which the LED lighting is lit and extinguished respectively charge is accumulated differs from one field to another. Eventually, a charge largely differs from one field to another, and the flicker becomes terrible.

However, flicker prevention exposure control with a shutter speed fixed is confronted with a problem that exposure cannot be adjusted using a shutter. In order to solve the problem, patent document 1 (JP-A-8-294058) has disclosed a method of substantially equally setting the shutter a predetermined number of times at intervals of a field period supported by each camera, performing exposure, and adjusting exposure using the shutter with a flicker reduced. Patent document 2 (JP-A-11-155106) devised by improving the patent document 1 has disclosed a method in which while a flicker is reliably removed according to the method of substantially equally setting the shutter a predetermined number of times at intervals of the field period supported by each camera during a period equivalent to the period during which the flicker occurs, exposure can be adjusted using the shutter.

An interest in a security field has grown along with a recent increase in the number of atrocious crimes, and a demand for a surveillance camera as imaging equipment intended to prevent a crime or record proofs has increased. The surveillance camera is, unlike a consumer product, used while being usually immobilized in a bank, a lift, a parking lot, a road, a vehicle, or the like. Each frame of an image provides precious information.

For example, a lift camera installed in a lift, a surveillance compact camera installed on an escalator, or a drive recorder designed to preserve or record image data for several tens of seconds acquired immediately prior to an impact occurring during running of a vehicle, and used to inspect or analyze an accident is often realized with an iris priority camera in efforts to simplify the structure. Therefore, exposure has to be adjusted using a shutter and AGC alone. In a picked up image, numerous scenes illuminated by illumination light from a light source such as a fluorescent light or an LED lighting are shown. Since missing of necessary information contained in the image or deterioration of the image may be invited due to a flicker dependent on the luminescence period for the illumination light, flicker removal processing is needed without fail.

As a solving means for a flicker in the surveillance camera, the method described in the patent document 1 or 2 is such that while a flicker is reduced or removed through exposure control to be achieved by substantially equally setting a shutter a predetermined number of times at intervals of a field period supported by each camera, exposure can be adjusted using the shutter. However, since the method adopts a technique of performing exposure plural times at intervals of the field period supported by each camera and summating exposure quantities, the method is confronted with a problem that as long as a subject makes movements, an afterimage or a blur is generated in an image of the subject more frequently than it is through ordinary shutter speed control. For the surveillance camera, it is important to reduce or remove a flicker. In addition, since each frame of an image provides precious information, information that is not degraded should preferably be acquired even from the image of the subject, which makes movements, without generation of the afterimage or blur.

### SUMMARY OF THE INVENTION

The present invention provides an exposure control method for imaging equipment which supports an inherent field period regarded as an image output unit and in which a CCD sensor records data owing to a light source that emits light at intervals of a specific period. The exposure control method is characterized in that: the timing of applying a discharging pulse at the time of beginning exposure and the timing of applying a charge readout pulse at the time of terminating the exposure are varied depending on a field in order to implement shutter speed control for the purpose of controlling exposure of the CCD sensor; the shutter speed control is implemented based on an exposure period shift by which an exposure period is shifted during a field; and the CCD sensor is exposed to a portion of light, which falls into the same phase thereof within the light-source luminescent period, during each field in order to remove a flicker.

When the timing of applying the discharging pulse at the time of beginning exposure and the timing of applying the charge readout pulse at the time of terminating the exposure are varied depending on a field, as soon as control is begun, exposure quantities attained during predetermined fields are sampled and an exposure period shift for a field during which the largest exposure quantity is attained is selected.

In addition, the shutter speed of the imaging equipment is equal to or larger than ½T where T denotes the luminescence period of the light source.

In addition, shutter speed control of exposure period shift is repeatedly implemented in units of a predetermined number of successive fields.

In addition, the CCD sensor of the imaging equipment outputs an image via an image memory during each field supported by the imaging equipment.

In addition, the CCD sensor of the imaging equipment alternately permits passage of a field during which image data acquired from the CCD sensor is outputted and preserved, and passage of another field during which the preserved image data is used to output image data.

Further, imaging equipment includes a lens through which an image of an entity illuminated by a light source that emits light at intervals of a specific period is picked up, a CCD sensor that converts the picked up image into an image signal, and an image processing device including a flicker control unit that discriminates a flicker from the image signal and instructs flicker removal, an exposure control part which controls exposure in response to the instruction made by the flicker control unit, and a shutter control unit that controls a shutter speed of the CCD sensor in response to an instruction made by the exposure control unit. The imaging equipment performs recording at intervals of an inherent field period which is regarded as an image output unit. In the imaging equipment, the shutter control unit controls the shutter speed by allowing the CCD sensor to vary field by field the timing of applying a discharging pulse at the time of beginning exposure and the timing of applying a charge readout pulse at the time of terminating the exposure, and allowing the CCD sensor to shift an exposure period, and exposes the CCD sensor to a portion of light, which falls into the same phase thereof within the light-source luminescent period, during each field.

Further, the shutter control unit includes a discharging pulse production part that produces the discharging pulse at the time of beginning exposure, a charge readout pulse production part that produces the charge readout pulse at the time of terminating the exposure, and a pulse timing management part that controls pulse production by the discharging pulse production part or charge readout pulse production part.

The present invention provides imaging equipment which adopts a CCD sensor as an image sensor and in which occurrence of an image flicker due to a periodic luminescent light source, which emits light dependently on a duration of a commercial power, is prevented by shifting the timing of beginning charge accumulation within a camera-supported imaging period. In addition, a high shutter speed can be set without generation of an afterimage of a dynamic subject or a blur.

### BRIEF DESCRIPTION OF THE DRAWINGS

FIG. 1A to FIG. 1G are explanatory diagrams showing a state in which a flicker appears, observed during imaging under light of an non-inverter system fluorescent light, and a state, in which no flicker appears, observed during the imaging;

FIG. 2A to FIG. 2G are explanatory diagrams showing a state, in which a flicker appears, observed during imaging under light of an LED lighting that emits light with a commercial AC power, and a state, in which no flicker appears, observed during the imaging;

FIG. 3 is a block diagram of imaging equipment in which flicker removal processing in accordance with an embodiment of the present invention is implemented;

FIG. 4 is an explanatory diagram showing an exposure control method based on an illuminance value obtained through program AE;

FIG. 5 is a flowchart describing processing of controlling a shutter speed;

FIG. 6 is an illustrative diagram showing a structure of a typical CCD sensor;

FIG. 7 is an illustrative diagram of an image signal output method implemented for shutter speed control of exposure period shift;

FIG. 8 is an explanatory diagram showing a method of shutter speed control of exposure period shift;

FIG. 9 is an explanatory diagram showing a method of selecting an initial exposure period shift;

FIG. 10 is an explanatory diagram showing a state in which a fluorescent-light flicker does not appear due to the shutter speed control of exposure period shift; and

FIG. 11 is an explanatory diagram showing a state in which an LED-lighting flicker does not appear due to the shutter speed control of exposure period shift.

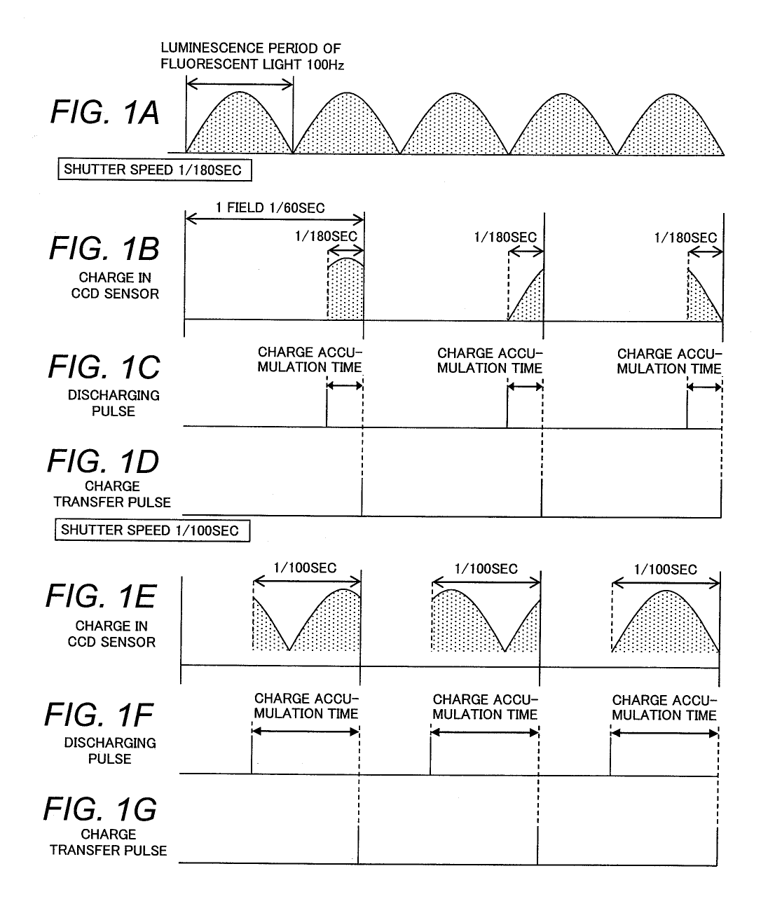

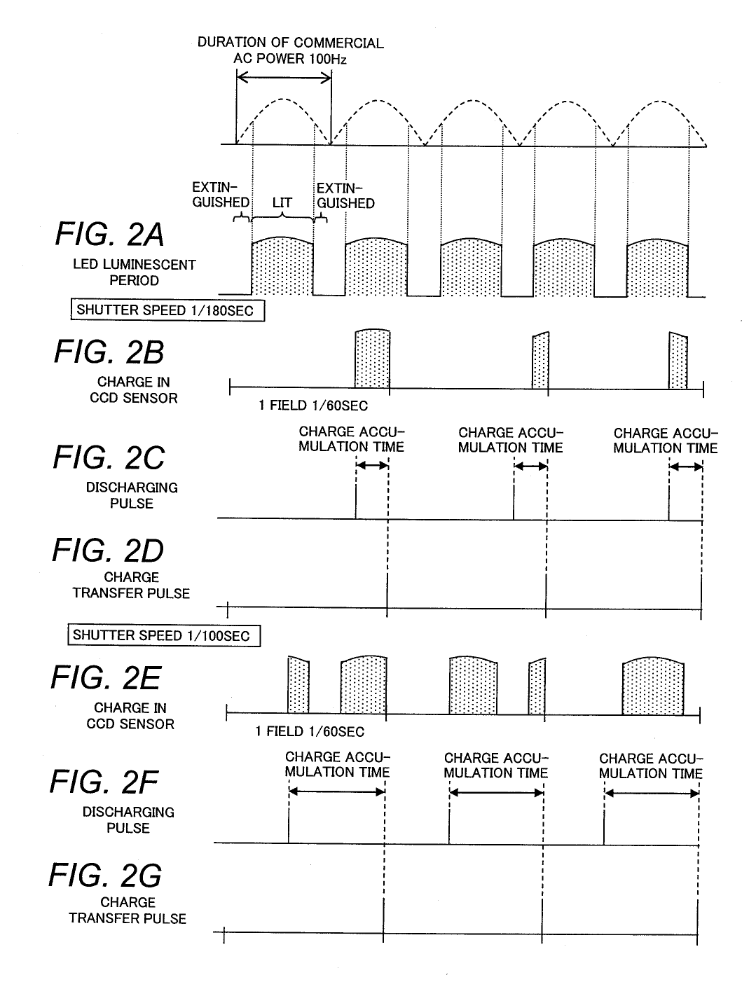

### DETAILED DESCRIPTION OF THE PREFERRED EMBODIMENTS

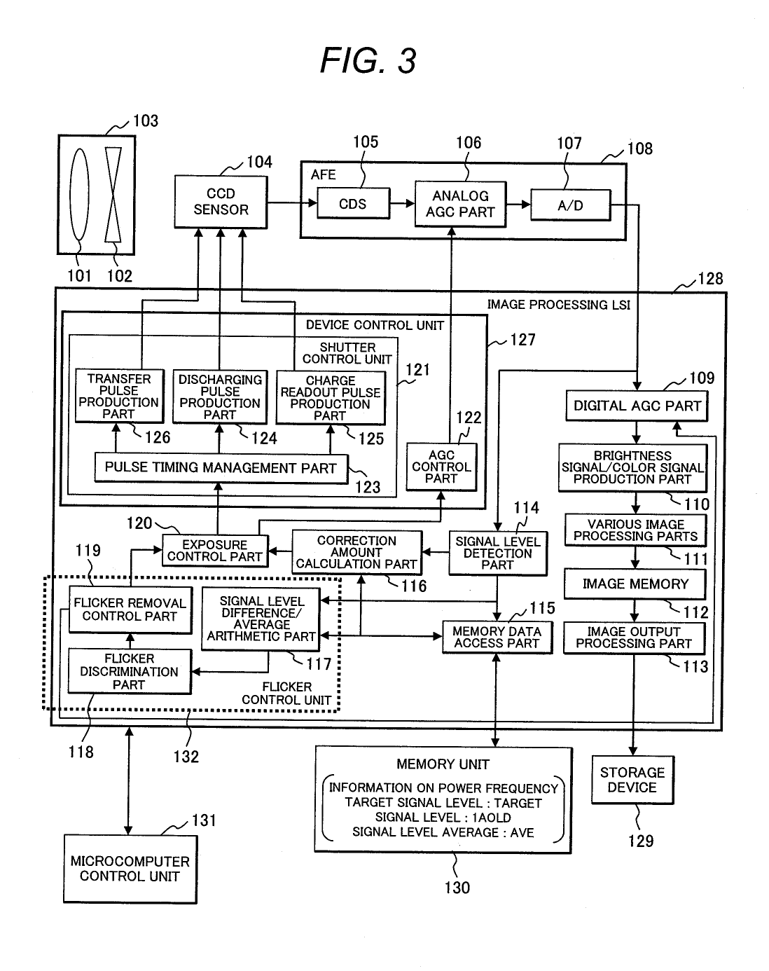

An embodiment of imaging equipment in accordance with the present invention will be described in conjunction with FIG. 3.

### A. Basic Configuration of Imaging Equipment

### (1) Description of the Imaging Equipment

FIG. 3 is a block diagram schematically showing imaging equipment that is an embodiment of the present invention and includes an iris priority camera in which a control circuit having a flicker removing capability is incorporated.

To begin with, actions to be performed during imaging and recording and signal flows will be described below. A picked up image is fed to a CCD sensor 104, which is an image sensor having a vertical transfer CCD and a horizontal transfer CCD, via an iris 102 that adjusts an amount of external light fetched through a lens 101 incorporated in a lens unit 103. The image is photoelectrically converted into an image signal, and inputted to an analog front-end (AFE) circuit 108. In the AFE circuit 108, the image signal passes through a correlated double sampling (CDS) part 105, an analog AGC part 106, and an analog-to-digital conversion part 107 so as to undergo CDS control, gain control, and analog-to-digital conversion. Thus, an analog-to-digital-converted image signal is provided.

The image signal outputted from the AFE circuit 108 is subjected to gain control by a digital AGC part 109 in an image processing LSI 127, has a brightness signal and a color signal produced therefrom by a brightness signal/color signal production part 110, and is then subjected to contour compensation, white balance control, and noise reduction by various image processing parts 111.

Thereafter, an image of one frame is stored in an image memory 112, converted into a standard television signal, which conforms to a predetermined television system, for example, the National Television System Committee (NTSC) standard or the phase alternation by line (PAL) standard, by an image output processing part 113, and then outputted to outside. A recording device 129 records the resultant signal in a recording medium.

The present imaging equipment includes a memory unit 130 in which various date items are stored. The image processing LSI 128 is controlled by a microcomputer control unit 131. Thus, various pieces of processing means are integrated into a sole LSI. Part of the control facilities of the image processing LSI 128 may be realized by software of a microcomputer but not by hardware. The present invention is not limited to this mode.

### (2) Camera Exposure Control

Next, exposure control for a camera will be described below. In FIG. 3, an image signal outputted from the AFE circuit 108 is fed to a signal level detection part 114 included in the image processing LSI 128. An image signal level value 1A for a current field is detected. A correction amount calculation part 116 compares the signal level value 1A for the current field with a target signal level TARGET, which is a predetermined exposure target value obtained from the memory unit 130 via a memory data access part 115, and calculates an exposure correction amount. The correction amount calculation part 116 calculates the exposure correction amount Z [dB] using the signal level value 1A for the current field and the target signal level TARGET according to an equation below.

Z=20×LOG(1A/TARGET)[dB] (1)

Thereafter, an exposure control part 120 controls exposure by selecting any of shutter speeds and any of parameters for AGC so that the exposure correction amount Z will be 0 dB, and controlling a device selected by a device control unit 127.

### (3) Device Control Unit

In FIG. 3, the device control unit 127 includes a shutter control unit 121 and an AGC control part 122, actuates either the shutter control unit 121 or the AGC control part 122, and thus controls exposure so that the signal level value 1A for the current field approaches the target signal level TARGET.

The shutter control unit 121 includes a pulse timing management part 123, a discharging pulse production part 124, a charge readout pulse production part 125, and a transfer pulse production part 126.

The shutter control unit 121 adjusts a charge by applying a discharging pulse, which causes photodiodes included in the CCD sensor to release discharge, a charge readout pulse, which causes the photodiodes in the CCD sensor to transfer charge to the vertical CCD, and a transfer pulse which includes a vertical transfer pulse and a horizontal transfer pulse and which causes the vertical CCD and horizontal CCD to transfer the charge, and thus controls exposure.

The AGC control part 122 adjusts sensitivity by controlling a gain provided by the analog AGC part 106 of the AFE circuit 108.

### (4) Switching Exposure Control Modes of the Device Control Unit

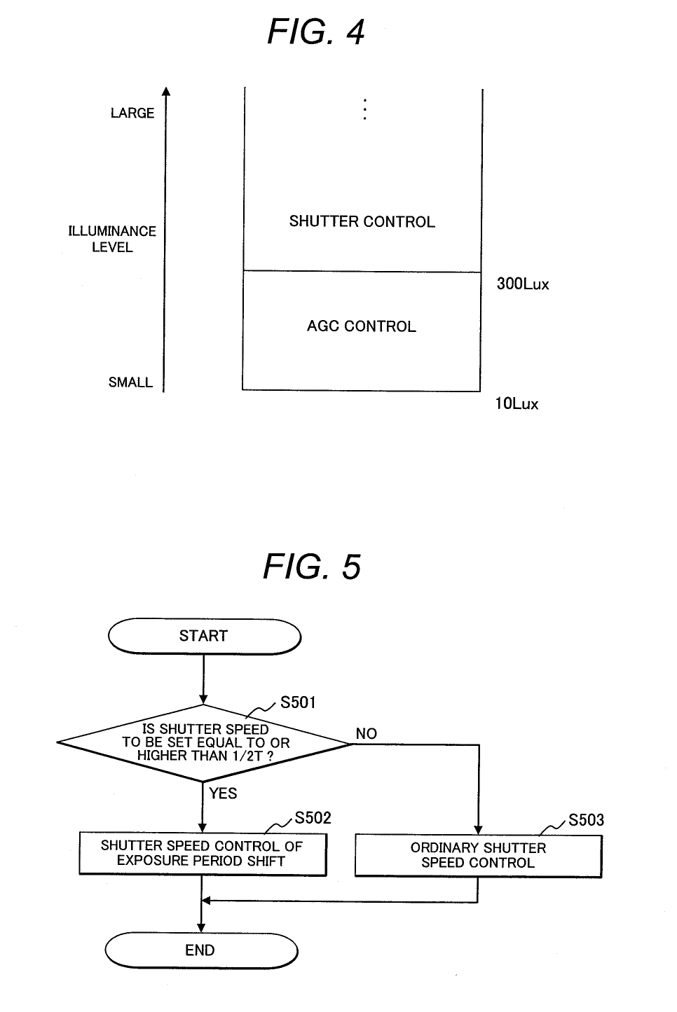

FIG. 4 is an explanatory diagram showing a reference illuminance level based on whichever of the shutter control unit 121 of the device control unit 127 and the AGC control part 122 thereof is used to control program AE is determined. When an image signal level is lower than 300 lux, it indicates a low-illuminance environment. Therefore, the exposure control part 120 selects conventional AGC so as to increase a gain to be given to the signal outputted from the CCD sensor. In a bright environment or a higher-illuminance environment, the shutter speed control in accordance with the present invention is selected in order to properly adjust exposure.

### (5) Flicker Control Part

Next, a flicker control unit 132 will be described below. In FIG. 3, the flicker control unit 132 includes a signal level difference/average arithmetic part 117, a flicker discrimination part 118, and a flicker removal control part 119, and controls flicker removal.

The signal level difference/average arithmetic part 117 produces a signal level difference value DIFF and an average field signal level AVE that are pieces of information needed by the flicker discrimination part 118 that discriminates a flicker. The signal level difference value DIFF is calculated using a previous-field signal level 1AOLD and a current-field signal level 1A, which are preserved in the memory unit 130, according to an equation below.

DIFF=1AOLD-1A (2)

As the average field signal level AVE preserved in the memory unit 130, only when the power supply is turned on, or only at an initial time, the signal level 1A that is detected by the signal level detection part 114 is stored in the memory unit 130 via the memory data access part 115. Thereafter, the signal level difference/average arithmetic part 117 uses the current-field signal level 1A, which is detected by the signal level detection part 114, and the average field signal level AVE, which is preserved in the memory unit 130, to solve an equation presented below.

AVE=(1A+AVE)/2 (3)

A calculated new average field signal level AVE is stored in the memory unit 130 via the memory data access part 115. The processing is repeated for each field.

The flicker discrimination part 118 decides whether the difference value DIFF and average level AVE are equal to or larger than thresholds TDIFF and TAVE respectively determined in the flicker discrimination part 118. If both the difference value DIFF and average level AVE are equal to or larger than the thresholds, the flicker discrimination part 118 decides that a flicker is present. More particularly, the signal level difference/average arithmetic part 117 acquires the average field signal level AVE, which is calculated during the previous field, from the memory unit 130 via the memory data access part 115, averages the current-field signal level 1A and average level AVE according to the equation (3), and preserves the calculated average value as the average signal level AVE in the memory unit 130. Whether the average level is equal to or larger than the threshold TAVE is decided, and whether the difference value DIET calculated according to the equation (2) is equal to or larger than the threshold TDIFF is decided. However, the flicker discrimination method is a mere example, and the present invention will not be limited to the method.

### (6) Flicker Removal Processing

Flicker removal processing includes exposure period shift processing (processing 1) in which the shutter control unit 121 in the device control unit 127 shown in FIG. 3 controls a shutter speed by shifting an exposure beginning position and an exposure termination position in the CCD sensor 104 for each field, and thus removes a flicker, and known AGC processing (processing 2) in which a signal variation is calculated based on the field signal level 1A obtained from the signal level detection part 114, and the flicker control unit 132 allows the digital AGC part 109 to correct a gain so as to thus remove a flicker.

When a decision is made that a flicker is present, the exposure control part 120 instructs the shutter control unit 121 of the device control unit 127 to select shutter speed control of exposure period shift, that is, the processing 1 of shifting the exposure beginning position for each field. If the flicker is not properly removed, the digital AGC part 109 is actuated in order to perform flicker removal processing, that is, the processing 2 of calculating a signal variation caused by the flicker so as to correct a gain through digital AGC.

### (7) Switching Shutter Speed Control Modes for Flicker Removal

FIG. 5 is a flowchart describing switching of modes of shutter speed control which the flicker discrimination part 118 implements in the course of the flicker removal processing 1. At step S501, whether a shutter speed to be set is equal to or higher than a shutter speed ½T [sec], which permits removal of a flicker, is decided. If the shutter speed is equal to or higher than ½T [sec], the shutter speed control of exposure period shift in accordance with the present invention is implemented at step S502. If the shutter speed is lower than ½T [sec], the conventional shutter speed control in which an exposure period is not shifted is implemented at step S503. Incidentally, T denotes a light-source luminescent frequency.

The shutter speed control of exposure period shift at step S502 is a control method capable of fully suppressing occurrence of a flicker at a shutter speed higher than ½T [sec], and preventing generation of an afterimage of a subject, which makes movements, or a blur. However, when the shutter speed falls below ½T [sec], shutter speed control of exposure period shift cannot be implemented. If the flicker discrimination part 118 decides that a flicker is present, the processing 2 is implemented all the time in order to cope with the low shutter speed.

### (8) CCD Sensor for Shutter Speed Control of Exposure Period Shift

Next, a CCD sensor to be used for shutter speed control of exposure period shift will be described below. The usable CCD sensors include various CCD sensors such as a typical CCD sensor that adopts a progressive method or an interlace method and has one horizontal CCD and one vertical CCD, a CCD sensor that has two vertical CCDs which transfer charge, and a CCD sensor having recording elements, in each of which charge of a photodiode is tentatively preserved, mounted in respective pixels thereon. In the present embodiment, a description will be made of the typical CCD sensor of a simple structure including one horizontal CCD and one vertical CCD.

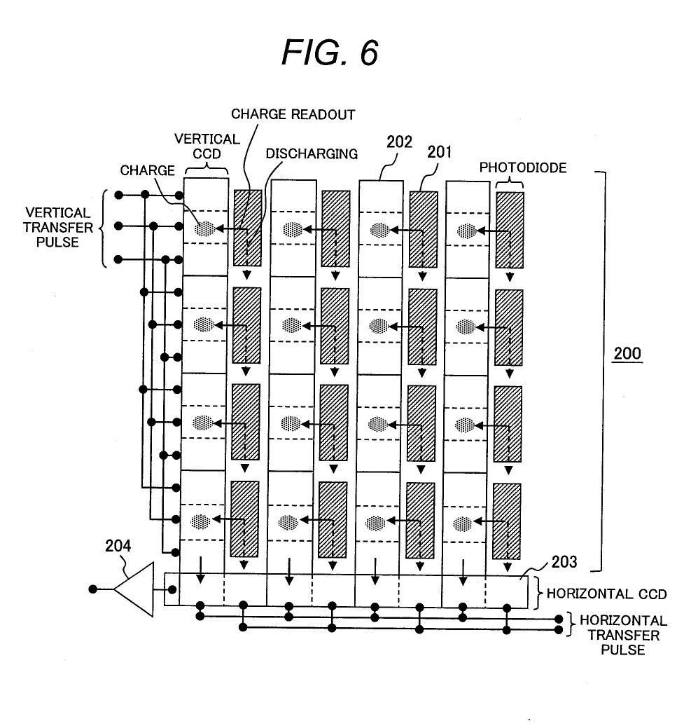

FIG. 6 shows the structure of a typical CCD sensor 200 having one horizontal CCD and one vertical CCD. Discharging and readout are performed on charge that is accumulated in each of photodiodes 201 on the CCD sensor 200 during one field period. The charges of the photodiodes 201 are tentatively released with a discharging pulse, and the charges in all pixels are then transferred to a vertical CCD 202 with a charge readout pulse. The charges of the photodiodes transferred to the vertical CCD 202 are carried to a horizontal CCD 203 with a vertical transfer pulse in units of one line. With a horizontal transfer pulse, the charges are carried from the horizontal CCD 203 to an output terminal in units of one pixel. A floating diffusion (FD) amplifier 204 detects charges that are converted into electric signals, and the electric signals of the pixels are outputted from the CCD sensor.

### B. Shutter Speed Control of Exposure Period Shift

Next, a method of shutter speed control of exposure period shift in accordance with the present invention will be described below.

### (1) Image Output Method for Shutter Speed Control of Exposure Period Shift

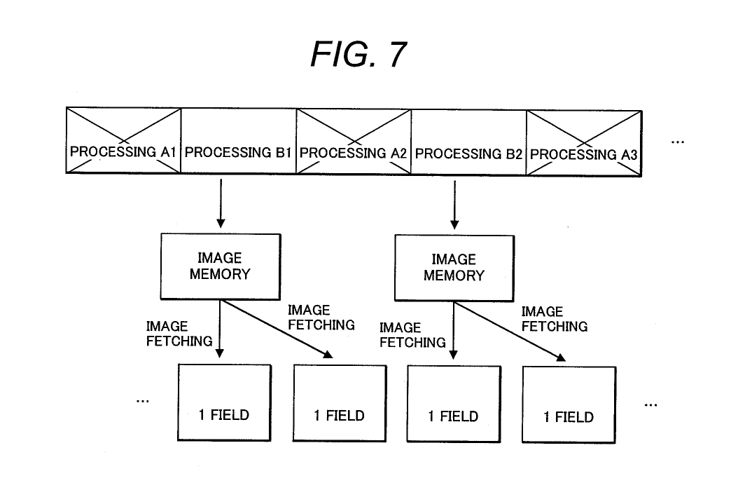

FIG. 7 is an illustrative diagram for explaining an image signal output method employed for shutter speed control of exposure period shift. When a CCD sensor that exhibits a typical processing speed is adopted for shutter speed control of exposure period shift, although ordinary shutter speed control is completed during one field during which an image is outputted via an image memory, two fields are necessary to complete the shutter speed control of exposure period shift. Specifically, assuming that processing A1 and processing A2 shown in FIG. 7 are represented by processing A and processing B1 and processing B2 are represented by processing B, one process is completed with the two different pieces of processing A and B.

During every processing B shown in FIG. 7, image data obtained from the CCD sensor is outputted and preserve. During every processing A, the image data preserved during the processing B is used to output an image. The process is repeatedly carried out. The image data is preserved in the image memory 112 shown in FIG. 3, and the image is outputted by the image output processing part 113.

However, if a high-speed CCD sensor capable of completing the two-field processing during one field is adopted, the processing need not be divided into the processing A and processing B but can be completed during one field. A camera conformable to, for example, the NTSC standard processes data for one field during 1/60 sec. For example, for driving a CCD sensor at a speed that is twice higher than an ordinary speed, an operating clock for the CCD sensor is doubled in order to drive the CCD sensor at the twice higher speed. As soon as charges accumulated in the respective photodiodes in the CCD sensor are transferred to the vertical CCD through the processing A during one field, the vertical transfer pulse and horizontal transfer pulse are applied at the twice higher speed through the processing B. Thus, the processing B and processing A can be performed during one field period but need not be assigned to different fields.

### (2) Shutter Speed Control of Exposure Period Shift

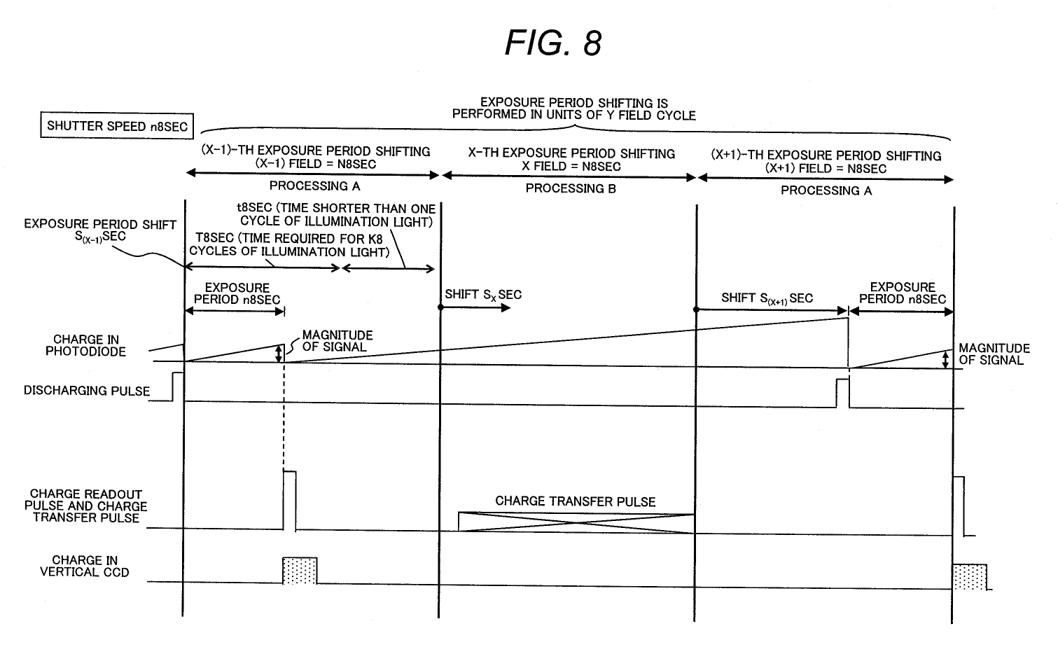

A control method for the CCD sensor intended to perform the processing A and processing B in the case of shutter speed control of exposure period shift will be described below. FIG. 8 shows shutter speed control of exposure period shift. In the drawing, a time corresponding to each field during which the processing A or processing B is performed is N8 [sec], a shutter speed to be set is n8 [sec], and exposure period shifts for an (X−1) field, an X field, and an (X+1) field respectively are S(X−1) [sec], SX [sec], and S(X+1) [sec] respectively.

What is referred to as an exposure period shift is a magnitude of a shift by which the timing of applying a discharging pulse for beginning exposure and the timing of applying a charge readout pulse for terminating the exposure are varied during each field in order to expose the CCD sensor to a portion of light, which falls into the same phase thereof within a light-source luminescent period, during each field. Even when a shutter speed remains unchanged, the timings of beginning and terminating charge accumulation differ from one field to another according to the shift.

Exposure period shifting is set to be completed within a Y field cycle. In FIG. 8, exposure period shiftings of S(X−1) sec long, SX sec long, and S(X+1) sec long respectively are repeated in units of a cycle 1Y [field] that includes three X fields during which the (X−1)-th shifting, the X-th shifting, and (X+1)-th shifting are carried out.

In ordinary shutter speed control, charge is accumulated in the photodiodes with application of a discharging pulse, and the charges in the all pixels are transferred to the vertical CCD with application of a charge readout pulse. Signals are outputted from the CCD sensor by repeating vertical transfer and horizontal transfer within the vertical CCD and horizontal CCD respectively. Application of the charge readout pulse is carried out on the border of each field period.

In contrast, shutter speed control of exposure period shift in accordance with the embodiment of the present invention is primarily characterized by a point that one field is assigned to repetition processing of discharging and charge readout, another field is assigned to charge transfer processing to be performed in the vertical CCD and horizontal CCD, and thus the pieces of processing are separated from each other as processing A and processing B. Processing that is performed during one field period through ordinary shutter speed control is performed as the two pieces of processing A and B at two times.

Secondly, the shutter speed control of exposure period shift is characterized by a point that the timings of beginning and terminating exposure are varied depending on a field by changing an exposure period shift by which the timings of beginning and terminating exposure are varied. Charge is not accumulated in the course of the processing B. However, the exposure period shift has to be calculated over the Y field cycle, and is therefore calculated even during the processing B. However, exposure period shifting is actually performed only in the course of the processing B.

The exposure period shift has to be calculated in units of a field. Since the exposure period shift is set for each field, the CCD sensor can be exposed to a portion of illumination light that falls into the same phase thereof within the luminescence period of a lighting that emits light dependently of a commercial AC power frequency T [Hz]. Therefore, an exposure quantity is held at the same value irrespective of a field. Eventually, a flicker can be reliably removed.

Depending on a portion of illumination light falling into what phase thereof within a luminescence period, an exposure quantity provided by the illumination light may be small or the CCD sensor may not be exposed to the illumination light. Therefore, control is implemented so that the CCD sensor can be exposed to the portion of illumination light falling into an optimal phase thereof within the luminescence period. The control will be detailed later.

The commercial AC power frequency T [Hz] falls into 50 Hz and 60 Hz. A shutter speed ½T [sec] is set to 1/100 sec for the power frequency of 50 Hz, and is set to 1/120 sec for the power frequency of 60 Hz. The information on the commercial AC power frequency is preserved in the memory unit 130 shown in FIG. 3. The information is acquired from the memory unit 130, and the shutter speed ½T [sec] is set to 1/100 sec or 1/120 sec.

The present invention is not limited to a commercial AC power. As long as a lighting emits light at intervals of a predetermined period, that is, as long as the luminescence period of the lighting is known, the technique of the present invention can be applied. When the flicker discrimination part 118 decides that a flicker is present, if a shutter speed is set to a speed higher than ½T [sec], shutter speed control of exposure period shift shown in FIG. 8 is implemented. When the shutter speed falls below ½T [sec], ordinary shutter speed control is implemented.

### (3) Shutter Speed Calculation Method

For implementing shutter speed control of exposure period shift, a Y field cycle including fields during which an exposure period is shifted as shown in FIG. 8, and an exposure period shift SX (where X denotes a natural number of 1, 2, etc.) to be made during each field have to be calculated. The exposure period shift is calculated based on an exposure period shift S(X−1) calculated during a field preceding a current field, and the pieces of processing are completed within one Y field cycle.

In FIG. 8, an exposure period shift is set to S(X−1), SX, and S(X+1), and one cycle includes three fields (Y=3). A shutter speed to be set for each field shall be n8 [sec] (exposure period) in common among the fields. First, the Y field cycle within which a shift is made is calculated. The time corresponding to each field is N8 [sec], and the cycle of illumination light is 2 T [Hz] where T [Hz] denotes a commercial AC power frequency.

(2T×Y)/(1/N8) (4)

A minimum value causing a remainder of a result of the above calculation to be null (0) is obtained as the Y field cycle within which an exposure period is shifted.

Next, a method of calculating an exposure period shift SX for the X-th exposure shifting, which is performed during an X field within the Y field cycle, as an exposure period shift for each field will be described below. First, assuming that K8 cycles of illumination light are observed during an (X−1) field period, K8 can be calculated as an integer value obtained by rounding down decimal places of a result of calculation provided as an expression below.

N8/(½T) (5)

A time T8 [sec] required by the K8 cycles of illumination light is calculated according to an equation presented below.

T8=(½T)×K8[sec] (6)

Assuming that t8 [sec] denotes a time that is shorter than one cycle of illumination light which extends from the (X−1) field of the Y field cycle to an X field, and that is included in the (X−1) field period, t8 can be calculated according to an equation presented below.

t8=N8−T8−S(X−1)[sec] (7)

The time that is shorter than one cycle of illumination light which extends from the (X−1) field period to the X field period and that is included in the current X field period is obtained. If an exposure beginning time and an exposure termination time during the X field or the current field within the Y field cycle are shifted by the time, the CCD sensor can be exposed to a portion of illumination light, which falls into the same phase thereof within the cycle of illumination light, during both the (X−1) field and X field within the Y field cycle.

The time that is shorter than one cycle of illumination light which extends from the (X−1) field and is included in the X field within the Y field cycle is calculated as an exposure period shift SX according to an equation presented below.

SX=(½T)−t8[sec] (8)

The exposure period shift SX calculated according to the equation (8) is nearly equal to the time ½T [sec] required for one cycle of illumination light, the shift SX is forcibly set to a nil. An exposure period shift S(X+1) [sec] for the (X+1) field within the Y field cycle can be calculated using the same method as the shift SX [sec] is.

### (4) Method of Calculating an Initial Exposure Period Shift

An initial exposure period shift for the (X−1)-th exposure shifting to be performed during an initial field within the Y field cycle is obtained according to a method to be described below instead of the aforesaid calculation method.

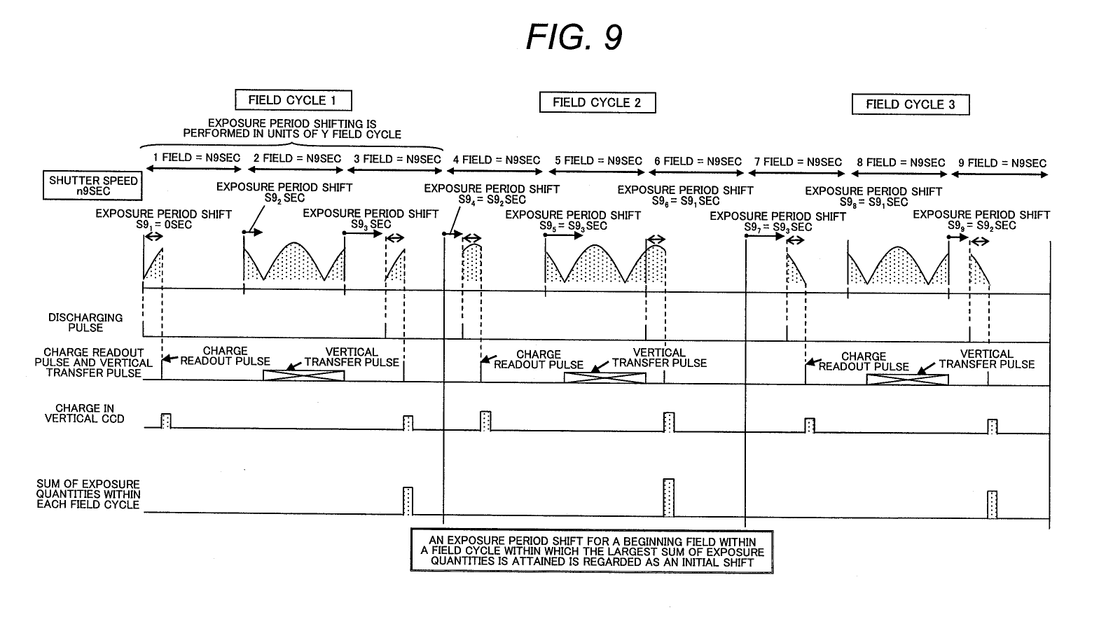

FIG. 9 shows a method of calculating an initial exposure period shift. When the flicker discrimination part 118 shown in FIG. 3 decides that a flicker is present, if the flicker removal control part 119 issues a flicker removal instruction to the exposure control part 120, shutter speed control of exposure period shift is implemented. In this case, as soon as implementation of the shutter speed control of exposure period shift is begun, the initial exposure period shift is determined.

A cycle within which an exposure period is shifted is a Y field cycle, and an exposure period shift SX (where X denotes a natural number of 1, 2, etc.) varies depending on a field. Therefore, an initial exposure period shift may be any of Y (the number of field cycles) exposure period shifts. First, the first exposure period shifting within the Y field cycle is performed Y times. At this time, the exposure period shift for the first field within a field cycle 1 that is the Y field cycle is set to S1=0 [sec] without fail.

In FIG. 9, the number of fields included in the cycle Y is three [Y=3]. Three exposure period shifts are therefore necessary. The exposure period shift for the first field is set to S1=0 [sec]. Within the field cycles of the field cycle 1, field cycle 2, and field cycle 3, the first exposure period shifting is performed with an exposure period shift determined as S1=0, S4, and S7 respectively. The exposure period shifts other than the exposure period shift S1 [sec] for the first exposure period shifting are obtained according to the expression and equations (5) to (8).

Exposure quantities obtained during the fields within each of the field cycles are added up, and the field cycle within which the largest sum of exposure quantities is obtained is selected. In the example shown in FIG. 9, the field cycle 2 is selected. The exposure period shift S4 for the first exposure period shifting to be performed within the field cycle 2 is adopted as an initial exposure period shift. Thus, the CCD sensor can be exposed to a portion of illumination light in a phase thereof within the cycle of the illumination light in which the large exposure quantity is obtained.

When shutter speed control of exposure period shift is in progress, the CCD sensor can be stably exposed to a certain amount of illumination light. For example, even if the illumination light is, like light of an LED lighting, emitted from a light source that is repeatedly lit and extinguished at intervals of a commercial power duration, the CCD sensor can reliably be exposed to a portion of the illumination light in a phase thereof in which the LED lighting is lit. Such an incident will not occur that the CCD sensor fails to catch the light of the LED lighting.

### (5) Concrete Example of Calculation for Shutter Speed Control of Exposure Period Shift

A concrete example of calculation of the Y field cycle and exposure period shift SX [sec], based on which an exposure period is shifted during each field, according to the expressions and equations (4) to (8) will be presented below. A description will be made of a calculation method for setting a shutter speed to S8= 1/180 sec on the assumption that a commercial AC power frequency T is 50 Hz, the time N8 of one field supported by the CCD sensor is 1/60 sec, and an initial exposure period shift is 0.003333 sec. To begin with, the Y field cycle within which an exposure period is shifted is calculated. Since the commercial AC power frequency T is 50 Hz and the time N8 of one field supported by the CCD sensor is 1/60 sec, a Y value causing the remainder of a calculation, which is performed according to the expression (4), to be a nil is calculated as 3 according to an equation (9) below.

(2T×Y)/(1/N8)=(2×50×3)/(1/( 1/60))=5 remainder 0(Y=3) (9)

The cycle within which an exposure period is shifted corresponds to three fields.

For the first field within a three-field cycle, an initial exposure period shift S1 calculated immediately after implementation of shutter speed control of exposure period shift is 0.003333 sec. Exposure period shifts for the second and succeeding fields are calculated according to the expression and equations (5) to (8). An exposure period shift S2 [sec] for the second field is obtained as expressed below according to the expression and equations (5) to (8). Assuming that K8 cycles of illumination light are observed during the first field period, the K8 value is calculated as an integer value obtained by rounding down the decimal places of the result of calculation, which is performed according to the equation (5), according to an equation (10) presented below.

N8/(½T)=( 1/60)/(1/(2×50))=1.666 . . . the number of decimal places to be rounded down: 1 (10)

The time T8 [sec] required for the K8 cycles of illumination light is calculated according to an equation (11) based on the equation (6) and presented below.

T8=(1/(2×T))×K8=(1/(2×50))×1=0.01[sec] (11)

A time t8 [sec] that is shorter than one cycle of illumination light which extends from the first field within the three-field cycle to the second field and which is included in the first field period is calculated according to an equation (12) based on the equation (7) and presented below.

t8=N8−T8−S1=( 1/60−0.01−0.003333=0.0033336666666666666666666666666667≈0.003334[sec] (12)

An exposure period shift S2 corresponding to a time that is shorter than one cycle of illumination light which extends from the first field and which is included in the second field within the three-field cycle is calculated according to an equation (13) based on the equation (8) and presented below.

S2=(1/(2×T))−t8=(1/(2×50)−0.003334=0.006666[sec] (13)

Likewise, an exposure period shift S3 for the third field within the three-field cycle is calculated to be 0.009999 sec. Since the value is approximated to a time 1/(2×50)=0.01 [sec] required for one cycle of illumination light, the exposure period shift S3 is calculated as 0 [sec].

As mentioned above, an exposure period is shifted within the three-field cycle within which the initial exposure period shift S1 for the first field thereof is set to 0.003333 sec, the initial exposure period shift S2 for the second field thereof is set to 0.006666 sec, and the initial exposure period shift S3 for the third field thereof is set to 0 sec. The processing is repeated in order to control a shutter speed. Eventually, while a flicker is removed, a high shutter speed of 1/100 sec or more can be realized. In addition, even when a subject that makes movements is imaged by a camera, neither an afterimage nor a blue is generated.

### C. Application to a Concrete Light Source

### (1) Removal of a Flicker Caused by a Fluorescent Light

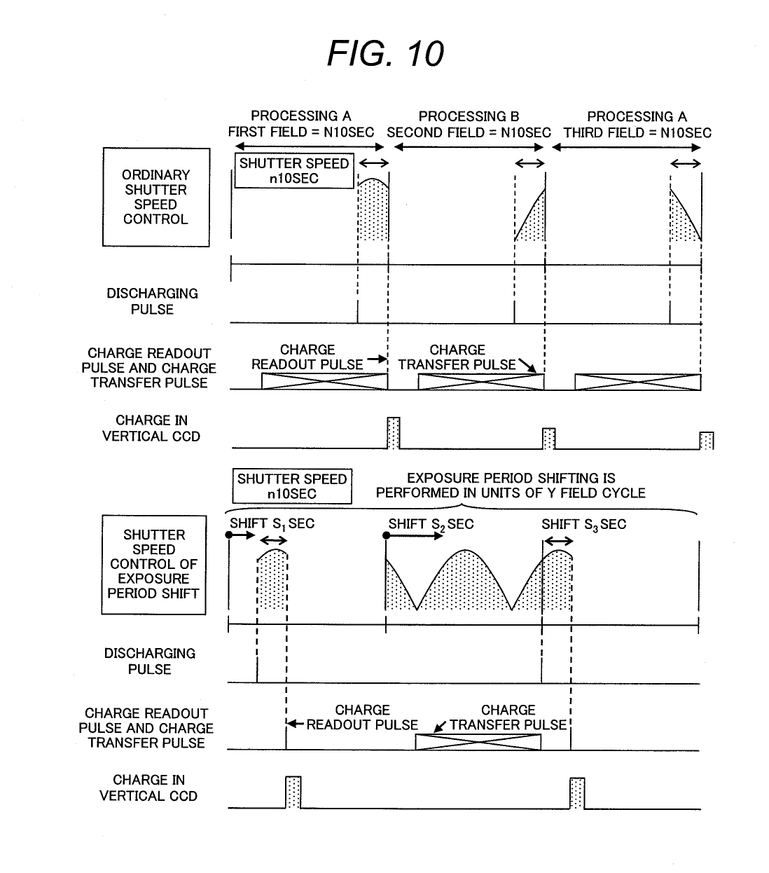

FIG. 10 shows a situation in which although a flicker is caused by a fluorescent light, when a shutter speed is set to n10 [sec] higher than ½T [sec], no flicker appears in an image. In FIG. 10, the results of ordinary shutter speed control and the results of shutter speed control of exposure period shift are compared with each other on the assumption that a shutter speed S10 [sec] equal to or higher than ½ T [sec] is set. In the ordinary shutter speed control, a discharging pulse and a charge readout pulse are applied once a field. At this time, the charge readout pulse is applied at a time point near the border between the field and an adjoining field. A time interval from a time when the discharging pulse is applied to a time when the charge readout pulse is applied is regarded as a shutter speed n10 [sec].

In contrast, in shutter speed control of exposure period shift, for setting a shutter speed n10 [sec], the timings of applying a discharging pulse and a charge readout pulse respectively are shifted by an exposure period shift calculated for each field. Control is implemented so that application of the charge readout pulse will not be limited to a time point near the border between fields.

Therefore, a shutter can be set at the same time point within a luminescence period of a fluorescent light, which corresponds to a phase of light giving the largest exposure quantity, during each field. Even when a shutter speed is high, a flicker can be removed. In addition, an afterimage of a subject or a blur can be suppressed in the same manner as it can through ordinary shutter speed control.

### (2) Removal of a Flicker Caused by an LED Lighting

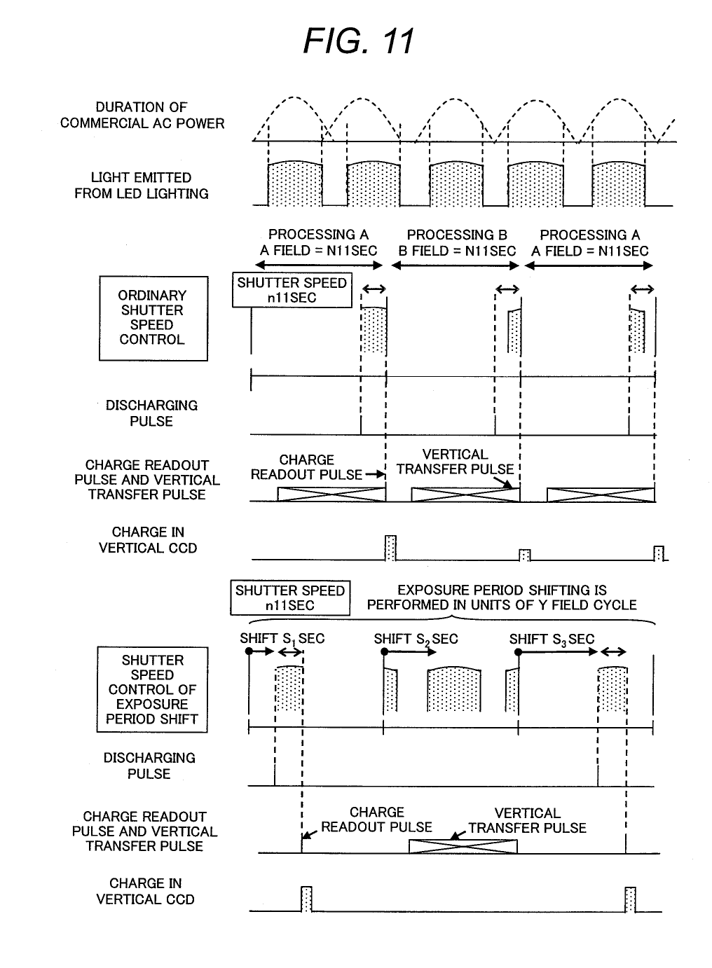

In FIG. 11, the results of ordinary shutter speed control and the results of shutter speed control of exposure period shift are shown in comparison with each other on the assumption that a commercial AC power frequency T [Hz] is changed to 2 T [Hz] through full-wave rectification, an LED lighting emits light while being repeatedly lit and extinguished, and a shutter speed n11 [sec] higher than ½ T [sec] is set. When the shutter speed n11 [sec] is set through the ordinary shutter speed control, as the value of the shutter speed n11 gets larger, a difference between exposure quantities attained during adjoining fields gets larger. Eventually, a flicker more terrible than that caused by a fluorescent light appears.

However, when shutter speed control of exposure period shift is implemented, a shutter can always be set at a time point within a luminescence period of an LED lighting, which corresponds to a phase of illumination light giving the largest exposure quantity, during each field. Even when a shutter speed is set to a value equal to or larger than ½T [sec], no flicker will appear. In addition, not only when the LED lighting is used but also when a scene containing a subject making a motion is imaged, the imaging can be achieved in the same manner as that through ordinary shutter speed control but an afterimage of the subject and a blur will not be worsened.

The present invention will prove effective in adjusting exposure without amplification of an afterimage or a blur while fully eliminating image deterioration caused by a flicker appearing when an imaging period differs from a specific period at intervals of which a lighting included in imaging equipment, which records a motion picture using a solid-state imager, emits light.

What is claimed is:

1. An exposure control method for imaging equipment, which supports an inherent field period regarded as an image output unit and in which a CCD sensor records data owing to a light source that emits light at intervals of a specific period, comprising the steps of:
varying the timing of applying a discharging pulse at the time of beginning exposure and the timing of applying a charge readout pulse at the time of terminating the exposure field by field so as to implement shutter speed control intended to control exposure of the CCD sensor;
implementing the shutter speed control based on an exposure period shift by which an exposure period is shifted during each field; and
exposing the CCD sensor to a portion of light, which falls into the same phase thereof within the light-source luminescent period, during each field so as to remove a flicker.

2. The exposure control method for imaging equipment according to claim 1, wherein when the timing of applying a discharging pulse at the time of beginning exposure and the timing of applying a charge readout pulse at the time of terminating the exposure are varied field by field, as soon as control is begun, exposure quantities attained during predetermined fields are sampled, and an exposure period shift for a field during which the largest exposure quantity is attained is selected.

3. The exposure control method for imaging equipment according to claim 1, wherein a shutter speed of the imaging equipment is equal to or larger than ½T where T denotes the light-source luminescent period.

4. The exposure control method for imaging equipment according to claim 1, wherein the shutter speed control based on an exposure period shift is repeatedly implemented with a predetermined number of successive fields as a unit.

5. The exposure control method for imaging equipment according to claim 1, wherein the CCD sensor of the imaging equipment outputs an image via an image memory during each field supported by the imaging equipment.

6. The exposure control method for imaging equipment according to claim 1, wherein the CCD sensor of the imaging equipment alternately permits passage of a field during which image data obtained from the CCD sensor is outputted and preserved, and passage of another field during which the preserved image data is used to output image data.

7. Imaging equipment comprising:
a lens through which an image of an entity illuminated by a light source that emits light at intervals of a specific period is picked up;
a CCD sensor that converts the picked up image into an image signal; and
an image processing device including a flicker control unit that discriminates a flicker from the image signal and instructs flicker removal, an exposure control part that controls exposure in response to an instruction made by the flicker control unit, and a shutter control unit that controls a shutter speed of the CCD sensor in response to an instruction made by the exposure control part, wherein
the imaging equipment uses an inherent field period, which is regarded as an image output unit, to perform recording,
the shutter control unit implements shutter speed control by allowing the CCD sensor to vary field by field the timing of applying a discharging pulse at the time of beginning exposure and the timing of applying a charge readout pulse at the time of terminating the exposure, and allowing the CCD sensor to shift an exposure period, and exposes the CCD sensor to a portion of light, which falls into the same phase thereof within the light-source luminescent period, during each field.

8. The imaging equipment according to claim 7, wherein the shutter control unit includes a discharging pulse production part that produces a discharging pulse at the time of beginning exposure, a charge readout pulse production part that produces a charge readout pulse at the time of terminating the exposure, and a pulse timing management part that controls pulse production by the discharging pulse production part or charge readout pulse production part.
